(19) United States
(12) Patent Application Publication
(10) Pub. No.: US 2003/0125112 A1
(43) Pub. Date: Jul. 3, 2003

(54) Method and apparatus for providing a multiplayer gaming environment

(76) Inventor: Kelan C. Silvester, Portland, OR (US)

Correspondence Address: David J. Kaplan, Intel Corporation, SC4-202, 2200 Mission College Blvd, Santa Clara, CA, 95052, US

(21) Appl. No.: 10/039,582

(22) Filed: Dec. 31, 2001

(51) Int. Cl. G06F 17/00

(52) U.S. Cl. 463/42

(57) ABSTRACT

In accordance with an embodiment of the present invention, a host may broadcast a gaming invitation. The invitation may be communicated to an invitee via the invitee's computer system if various parameters set by the invitee are met, including, for example, a time of day, a game type, a host identity, a location of the host or invitee, etc. If the invitation is communicated to the invitee, the invitee may accept or reject the invitation. If the gaming invitation is accepted by the invitee, multiplayer gaming between the host and the invitee may begin. For one embodiment of the present invention, a crasher may subsequently request to join a game in progress, and the host may accept or reject the crasher as an additional player. When the host signs off from a game in progress, host privileges may be transferred to another player.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers. Computer systems may take many different forms, providing many different services for a user. One type of service is game playing. Computer systems that provide game playing typically include the game software, a video interface, and one or more input devices.

Although many computer games offer an option that enable the user to play alone (or play against the computer), it may be more fun and more challenging for the user to play against a live opponent. Unfortunately, friends are not always readily available to provide the user with a multiplayer gaming environment. The present invention addresses this and other problems associated with the prior art.

### BRIEF DESCRIPTION OF THE DRAWINGS

The present invention is illustrated by way of example and not limitation in the accompanying figures in which like references indicate similar elements and in which:

FIG. 1 includes a computer system in accordance with an embodiment of the present invention;

FIG. 2 includes a multiplayer gaming environment formed in accordance with an embodiment of the present invention;

FIG. 3 includes a flow chart showing a method of an embodiment of the present invention; and

FIG. 4 includes a flow chart showing another method of an embodiment of the present invention.

### DETAILED DESCRIPTION

In accordance with an embodiment of the present invention, a host may broadcast a gaming invitation. The invitation may be communicated to an invitee via the invitee's computer system if various parameters set by the invitee are met, including, for example, a time of day, a game type, a host identity, a location of the host or invitee, etc. If the invitation is communicated to the invitee, the invitee may accept or reject the invitation. If the gaming invitation is accepted by the invitee, multiplayer gaming between the host and the invitee may begin. For one embodiment of the present invention, additional invitees may accept the gaming invitation and play as well. A crasher may subsequently request to join a game in progress, and the host may accept or reject the crasher as an additional player. When the host signs off from a game in progress, host privileges may be transferred to another player.

A more detailed description of embodiments of the present invention, including various configurations and implementations, is provided below.

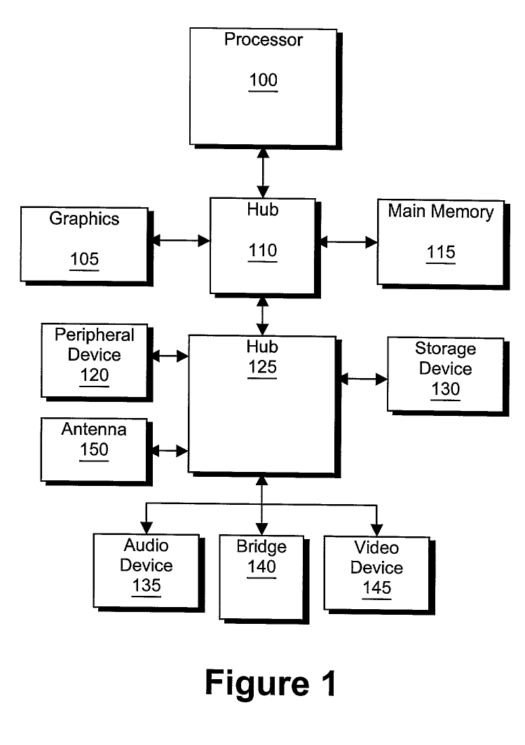

FIG. 1 includes a computer system that may be used in accordance with an embodiment of the present invention. As shown, the computer system may include a processor 100 coupled to hub 110. Processor 100 may communicate with graphics controller 105, main memory 115, and hub 125 via hub 110. Hub 125 may couple peripheral device 120, storage device 130, audio device 135, video device 145, antenna 150, and bridge 140 to hub 110.

Audio device 135 may include, for example, a speaker, a microphone, or other input/output device. Video device 145 may include, for example, a display screen, a camera, or other video input/output device. Bridge 140 may couple hub 125 to one or more additional buses coupled to one or more additional peripheral devices. Antenna 150 may couple the computer system to one or more wireless networks in accordance with one or more wireless communication protocols. Peripheral device 120 may be one or more other peripheral devices.

In accordance with an embodiment of the present invention, a computer system may include more or fewer components than those shown in FIG. 1, and the components of FIG. 1 may be partitioned differently. For example, multiple components may be integrated into a single component, and single components may be divided into multiple components. Note that the term “processor” may be used herein to refer to one or more of a central processing unit, a processor of a symmetric or asymmetric multiprocessing system, a digital signal processor, a micro-controller, etc.

A method of an embodiment of the present invention may be implemented by the computer system of FIG. 1 programmed to execute instructions associated with the method. These instructions may reside, at least in part, in any machine-readable medium such as a magnetic disk (e.g. a hard drive or floppy disk), an optical disk (e.g. a CD or DVD), a semiconductor device (e.g. Flash, EPROM, or RAM), or a carrier wave (e.g. an electrical or wireless data signal), all of which are collectively represented by storage device 130 of FIG. 1.

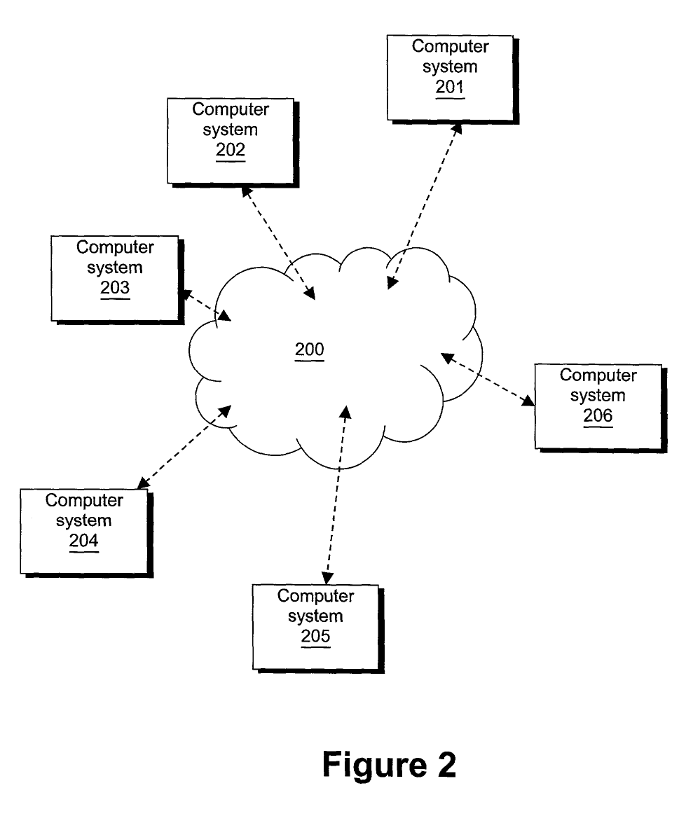

FIG. 2 includes a multiplayer gaming environment formed in accordance with an embodiment of the present invention. Computer systems 201-206 may be wirelessly connected via wireless network 200. For an embodiment in which wireless network 200 operates in accordance with a short range wireless communication protocol, computer systems 201-206 may be in close proximity to each other. This embodiment may be found useful in an office environment between co-workers, in a social environment between friends, or in a close proximity public environment such as an airplane. Alternatively, where wireless network 200 operates in accordance with a long range wireless communication protocol, computer systems 201-206 may be remote to each other. For another embodiment, network 200 may be a wired network. In accordance with an embodiment of the present invention, anonymity of the players may be maintained if desired.

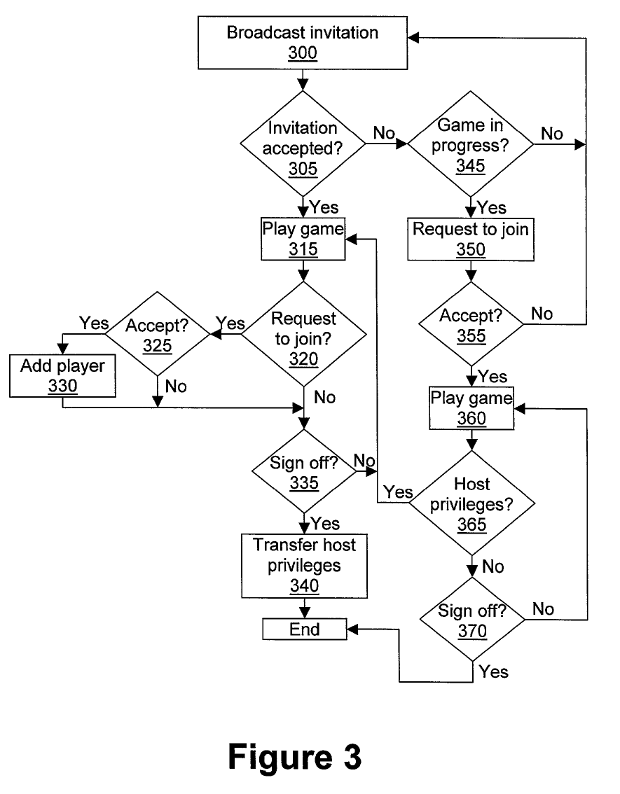

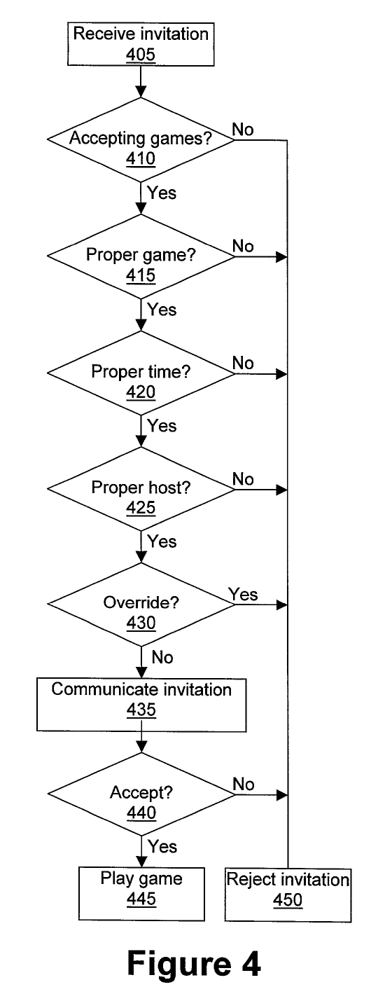

FIG. 3 includes a flow chart showing a method of an embodiment of the present invention. The flow chart of FIG. 3 shows a method from the perspective of a single user who may be a host or a crasher. At block 300, a game may be initiated by the user by broadcasting a gaming invitation using a first computer system. In accordance with one embodiment of the present invention, this gaming invitation may include information used by one or more computer systems of one or more invitees to determine if the invitation is to be communicated to the one or more invitees, as described in more detail below in conjunction with FIG. 4. For example, the invitation may include an indication of the specific game the user desires to play. For another embodiment, the invitation may identify the user, and the invitees may also be identified at their discretion. For an alternate embodiment, the user may remain anonymous, along with the invitees.

In accordance with an embodiment of the present invention, at block 305 of FIG. 3 the user may be notified if an invitee accepts the gaming invitation. If an invitee accepts the invitation, the invitee becomes a game player and the game may begin at block 315. For one embodiment of the present invention, the user may be considered the game's “host” at block 315. In accordance with an embodiment of the present invention, more than one invitee may accept the broadcast invitation at block 305. If the game can support enough players, all invitees that accept the invitation may participate as game players at block 315. In accordance with an alternate embodiment of the present invention, the host may be notified about other games in progress, at block 345, even if the invitation is accepted at block 305. For this embodiment, the user may desire to attempt to join a game already in progress rather than initiate a new game.

In accordance with an embodiment of the present invention, another user may request to the join the game in progress if the game can support an additional player at block 320 of FIG. 3. This additional user may be referred to as a game crasher. If the crasher requests to join the game at block 320, the request is presented to the game host. The game host may then accept or reject the request at block 325. If the host accepts the request, the crasher may be added as an additional player at block 330. If the host rejects the request, the crasher may not be added.

In accordance with an embodiment of the present invention, the game may continue until it ends or the players lose interest and sign off. If, at block 335 of FIG. 3, the host signs off, host privileges may be transferred to another player at block 340. Host privileges may include, for example, accepting or rejecting a crasher's request to join the game. Host privileges may additionally include, for example, defining one or more parameters of the game, selecting the game, selecting the level of difficulty of the game, setting a limit to the number of game players, etc.

In accordance with an embodiment of the present invention, if the user's invitation is not accepted at block 305 of FIG. 3, the user may be nitified if a game is already in progress at block 345. This determination may be done automatically in response to the user broadcasting a gaming invitation at block 300, or it may be done in response to a specific query initiated by the user. If it is determined at block 345 that no game is in progress (and no invitations to game are accepted at block 305), the user may wait and broadcast another gaming invitation at block 300. In accordance with one embodiment of the present invention, broadcasting the gaming invitation may be done automatically on a regular basis (e.g. every minute) at the behest of the user for a predetermined period of time or until the user deactivates this feature. Alternatively, broadcasting the gaming invitation may be done only once in response to a single user request.

For one embodiment of the present invention, if it is determined at block 345 that a game is already in progress, the user may request to join the game as a crasher at block 350 of FIG. 3. If the request is not accepted by the game host at block 355, the process returns to block 300. If, however, the request is accepted by the game host, the user may join the game as a player at block 360. In accordance with an embodiment of the present invention, the game may continue for the user until the game ends or the players lose interest and sign off.

In accordance with an embodiment of the present invention, if the game host signs off, host privileges may be transferred to another player, as described above. If, at block 365 of FIG. 3, host privileges are transferred to the user, the user becomes a host and gaming continues at block 315. The user may sign off at block 370.

FIG. 4 includes a flow chart showing another method of an embodiment of the present invention. The flow chart of FIG. 4 shows a method from the perspective of a single user who is an invitee. At block 405, a gaming invitation may be received by the user's computer system. This invitation may be broadcasted from another user's computer system. A series of filters may then be applied to determine if the invitation is to be communicated to the user. For example, at block 410 it is determined if the user is accepting gaming invitations. This determination may be made in accordance with a user-selectable option on the user's computer system to accept or reject gaming invitations.

In accordance with an embodiment of the present invention, if the user is accepting gaming invitations, it may next be determined at block 415 of FIG. 4 if the invitation is for a proper game. This determination may be made in accordance with a user-selectable option on the user's computer system to specify the games or game types that the user may wish to play. For example, a user, if invited, may wish to play logic games but not trivia games. In accordance with this embodiment, the gaming invitation that may be broadcasted to the user may include an indication as to the game or game type that the initiator desires to play. Alternatively, this information may not be broadcasted. For example, the host may not have predetermined the game to be played. The game selection may instead be based on, for example, the types of computer systems in the gaming environment, the software installed on those systems, a random selection, or the desires of the invitee.

In accordance with an embodiment of the present invention, if the invitation is for the proper game, it may next be determined at block 420 of FIG. 4 if the invitation is sent at the proper time. This determination may be made in accordance with a user-selectable option on the user's computer system to specify the times that the user may want to play or may not want to play. For example, a user's computer system may be configured by the user to reject games between 8 a.m. and 5 p.m., Monday through Friday, holidays excepted. Alternatively a user's computer system may be configured by the user to accept games between 12 p.m. and 1 p.m. Monday through Friday.

In accordance with an embodiment of the present invention, if the invitation is at the proper time, it may next be determined at block 425 of FIG. 4 if the invitation is sent by the proper host. This determination may be made in accordance with a user-selectable option on the user's computer system to specify particular players that the user may want to play with or may not want to play with. For example, a user's computer system may be configured by the user to reject games from a particular person or group of people. Alternatively a user's computer system may be configured by the user to accept games from a particular person or group of people. In accordance with this embodiment, the gaming invitation that may be broadcasted to the user may include an indication as to the identify of the host. For an alternate embodiment, the host may remain anonymous.

In accordance with an embodiment of the present invention, if the invitation is sent by the proper host, it may next be determined at block 430 of FIG. 4 if there are any override features in effect. This determination may be made in accordance with one or more user-selectable options on the user's computer system to specify other filtering parameters associated with gaming invitations. For example, a user's computer system may be configured by the user to reject or accept games according to the location of the host. For another embodiment, a user's computer system may be configured by the user to reject or accept games according to the location of the user. For another embodiment, a user's computer system may be configured by the user to reject or accept games according to the bandwidth or features of the host's or the user's computer system. For another embodiment, a user's computer system may be configured by the user to reject or accept games according to other tasks the user may be performing. For example, the system may be configured to reject games if the user is using the phone (e.g. for an embodiment in which the computer system includes a cell phone). As another example, the system may be configured to reject games if the user is watching a movie, working on a spreadsheet, or already playing another game.

If no override features are in effect at block 430 of FIG. 4, the gaming invitation may be communicated to the user at block 435. In accordance with an embodiment of the present invention, a gaming invitation is deemed to be communicated to an invitee by the computer system if the system presents the invitee with an option on the display screen to either accept or reject the invitation. An invitation that is not communicated to an invitee may instead be logged or otherwise noted by a subtle audio or video cue by the computer system.

In accordance with an embodiment of the present invention, the user may affirmatively accept or reject the communicated invitation at block 440 of FIG. 4. If the invitation is accepted by the user, the user may play the game at block 445. Otherwise the invitation may be rejected at block 450. In accordance with one embodiment of the present invention, the process may continue from block 445 of FIG. 4 to block 360 of FIG. 3.

This invention has been described with reference to specific exemplary embodiments thereof. It will, however, be evident to persons having the benefit of this disclosure that various modifications and changes may be made to these embodiments without departing from the broader spirit and scope of the invention. The specification and drawings are, accordingly, to be regarded in an illustrative rather than a restrictive sense.

What is claimed is:

1. A machine-readable medium including machine-readable instructions that, if executed by a computer system, cause the computer system to perform a method comprising:
broadcasting a gaming invitation from a host;
enabling the host to play a first game with an invitee in response to the
invitee accepting the gaming invitation; and
enabling the host to accept or reject a request to join the first game from a crasher.

2. The medium of claim 1, wherein the method further comprises transferring host privileges to the invitee in response to the host signing off.

3. The medium of claim 1, wherein the method further comprises determining if a second game is in progress in response to the invitee rejecting the invitation.

4. The medium of claim 3, wherein the method further comprises requesting to join the second game in response determining that the second game is in progress.

5. A system comprising:
a processor to execute a game;
a display to provide video feedback associated with the game; and
a memory region including instructions that, if executed by the processor, cause the system to transfer a host privilege from a host to a player in response to the host signing off the game.

6. The system of claim 5, wherein the host privilege includes a right to accept or reject a request from a crasher to join the game.

7. A machine-readable medium including machine-readable instructions that, if executed by a computer system, cause the computer system to perform a method comprising:
determining that a game is in progress; and
joining the game if a host of the game accepts a request to join the game.

8. The medium of claim 7, wherein the method further comprises determining that the game is in progress in response to broadcasting a gaming invitation.

9. The medium of claim 8, wherein the method further comprises re-broadcasting the gaming invitation in response to the host rejecting the request.

10. The medium of claim 8, wherein the method further comprises sending the request to join the game in response to broadcasting the gaming invitation.

11. The medium of claim 7, wherein the method further comprises sending the request to join the game in response to broadcasting a gaming invitation.

12. A system comprising:
a processor to execute a game; and
a memory region including instructions that, if executed by the processor, cause the system to enable a user to accept or reject a broadcast gaming invitation from a host computer according to a predefined condition.

13. The system of claim 12, wherein the predefined condition includes a time of day.

14. The system of claim 12, wherein the predefined condition includes a type of the game.

15. The system of claim 12, wherein the predefined condition includes an identity of the host computer.

16. The system of claim 12, wherein the predefined condition includes a configuration of the host computer.

17. The system of claim 12, wherein the predefined condition includes a location of the system or a location of the host computer.
